(19) United States
(12) Patent Application Publication
(10) Pub. No.: US 2025/0368809 A1
(43) Pub. Date: Dec. 4, 2025

(54) RESIN COMPOSITION

(71) Applicant: NAN YA PLASTICS CORPORATION, Taipei City (TW)

(72) Inventors: Ching-Yao Yuan, Taipei City (TW); Hung-Yi Chang, Taipei City (TW); Li-Ting Wang, Taipei City (TW); Wei-Ru Huang, Taipei City (TW)

(73) Assignee: NAN YA PLASTICS CORPORATION, Taipei City (TW)

(21) Appl. No.: 18/776,187

(22) Filed: Jul. 17, 2024

(30) Foreign Application Priority Data
May 30, 2024 (TW) 113120001

(51) Int. Cl. C08L 21/00; C08K 9/06

(52) U.S. Cl. CPC C08L 21/00; C08K 9/06; C08K 2201/005; C08L 2207/324

(57) ABSTRACT

A resin composition is provided. The resin composition includes a resin mixture (A), a liquid rubber resin (B), an organic filler (C), a catalyst (D) and a siloxane coupling agent (E). The resin mixture (A) includes a bismaleimide resin.

### CROSS-REFERENCE TO RELATED APPLICATION

This application claims the priority benefit of Taiwan application serial no. 113120001, filed on May 30, 2024. The entirety of the above-mentioned patent application is hereby incorporated by reference herein and made a part of specification.

### BACKGROUND

### Technical Field

The present invention relates to a resin composition.

### Description of Related Art

In recent years, with the development of fifth generation mobile networks (referred to as 5G), the demand for copper-clad laminate materials that may transmit large amounts of data has also increased. When pursuing high-speed transmission, the surface roughness of the copper foil may be reduced (for example, Rz less than 0.5 microns) to provide good signal transmission performance at high frequencies. However, reduced surface roughness of the copper foil may lead to poor physical adhesion to the circuit board in the laminate structure (e.g., peel strength less than 2 lb/in). Therefore, there is an urgent need for a solution that may solve the above problems.

### SUMMARY

The present invention provides a resin composition that may have good dielectric properties, peel resistance and heat resistance.

A resin composition of the present invention includes a resin mixture (A), a liquid rubber resin (B), an inorganic filler (C), a catalyst (D) and a siloxane coupling agent (E). The resin mixture (A) includes a bismaleimide resin.

In one embodiment of the present invention, the bismaleimide resin includes a bismaleimide-modified olefin-based resin, a bismaleimide-modified polyphenylene ether resin, a bismaleimide-modified dicyclopentadiene-based resin or a combination thereof.

In one embodiment of the present invention, the bismaleimide resin further includes a biphenyl-based bismaleimide resin.

In one embodiment of the present invention, a weight average molecular weight of the bismaleimide resin is 500 g/mol to 5000 g/mol.

In one embodiment of the present invention, based on a total usage amount of the resin composition being 100 parts by weight, a usage amount of the resin mixture (A) is 10 parts by weight to 30 parts by weight.

In one embodiment of the present invention, the liquid rubber resin (B) includes LDM-02, LF-310T50, COD-103, a divinylbenzene-containing polymer or a combination thereof.

In one embodiment of the present invention, the inorganic filler (C) includes silicon dioxide.

In one embodiment of the present invention, the inorganic filler (C) includes a surface-modified silicon dioxide with acrylic or vinyl group.

In one embodiment of the present invention, the inorganic filler (C) has a median particle size of 0.3 microns to 3.0 microns.

In one embodiment of the present invention, the siloxane coupling agent (E) includes a vinyl silane compound, an acrylic silane or a combination thereof.

In one embodiment of the present invention, based on a total usage amount of the resin composition being 100 parts by weight, a usage amount of the liquid rubber resin (B) is 30 parts by weight to 50 parts by weight, a usage amount of the inorganic filler (C) is 25 parts by weight to 50 parts by weight, a usage amount of the catalyst (D) is 0.1 parts by weight to 2 parts by weight, a usage amount of the siloxane coupling agent (E) is 0.1 parts by weight to 5 parts by weight.

Based on the above, the resin composition of the present invention includes a resin mixture (A), a liquid rubber resin (B), an inorganic filler (C), a catalyst (D) and a siloxane coupling agent (E), wherein the resin mixture (A) includes a bismaleimide resin. Thereby, the resin composition may have good dielectric properties, peel resistance and heat resistance.

In order to make the above-mentioned features and advantages of the present invention more obvious and understandable, examples are given below and are described in detail below.

### DESCRIPTION OF THE EMBODIMENTS

The following are examples that describe the content of the present invention in detail. The implementation details provided in the embodiments are for illustrative purposes and are not intended to limit the scope of protection of the present invention. Anyone with ordinary knowledge in the art may modify or change these implementation details according to the needs of the actual implementation.

Herein, the range expressed by “one value to another value” is a summary expression that avoids enumerating all the values in the range one by one in the specification. Therefore, the description of a specific numerical range covers any numerical value within the numerical range and the smaller numerical range defined by any numerical value within the numerical range, just as the arbitrary numerical value and the smaller numerical range written in the explanatory text of the specification.

### <Resin Composition>

The invention provides a resin composition, which includes a resin mixture (A), a liquid rubber resin (B), an inorganic filler (C), a catalyst (D) and a siloxane coupling agent (E). In addition, the resin composition of the present invention may further include other additives according to needs. Below, the various components mentioned above will be described in detail.

### Resin Mixture (A)

The resin mixture (A) includes a bismaleimide (BMI) resin. The bismaleimide resin is not particularly limited, and an appropriate bismaleimide resin may be selected according to needs. In this embodiment, the bismaleimide resin may include a bismaleimide-modified olefin-based resin, a bismaleimide-modified polyphenylene ether resin (PPE-BMI), a bismaleimide-modified dicyclopentadiene-based resin (DCPD-BMI), a combination thereof or other suitable bismaleimide resins.

The bismaleimide-modified olefin-based resin may include BMI-3000 (trade name; manufactured by DMI (Designer Molecules Inc.) or other suitable bismaleimide-modified olefin-based resins.

The bismaleimide-modified polyphenylene ether resin may be the bismaleimide-modified polyphenylene ether resin disclosed in Taiwan Patent Publication No. 1774559 or other suitable bismaleimide-modified polyphenylene ether resin. The entire disclosure of Taiwan Patent Publication No. 1774559 is incorporated herein by reference. For example, the chemical structure of the bismaleimide-modified polyphenylene ether resin may be represented by the following Formula (1).

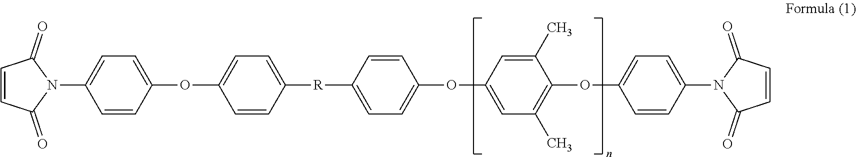

In Formula (1),
R may be a direct bond, methylene group, ethylene group, isopropyl group, 1-methylpropylene group, sulfonyl group or fluorenyl cardo group, and
n may represent an integer from 3 to 25, preferably an integer from 10 to 18.

The bismaleimide-modified dicyclopentadiene-based resin may be the bismaleimide-modified dicyclopentadiene-based resin disclosed in Taiwan Patent Application No. 112131621 or other suitable bismaleimide-modified dicyclopentadiene-based resins. The entire disclosure of Taiwan Patent Application No. 112131621 is incorporated herein by reference. For example, the chemical structure of the bismaleimide-modified dicyclopentadiene-based resin may be represented by the following Formula (2).

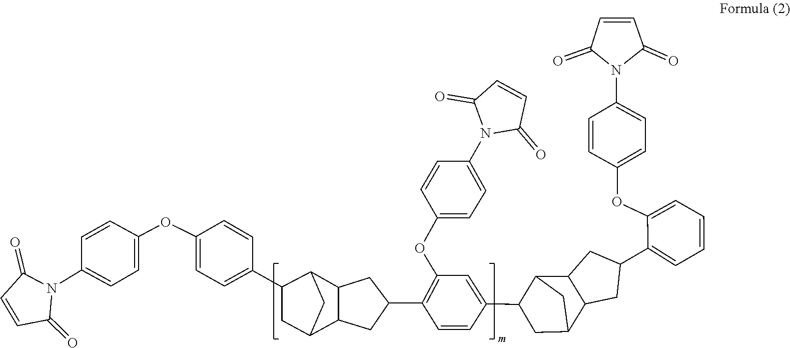

In Formula (2),
m may represent an integer from 0 to 18, preferably an integer from 2 to 10.

The bismaleimide resin may further include a biphenyl-based bismaleimide resin or other suitable maleimide resins. The biphenyl-based bismaleimide resin may include a fluorinated biphenyl-based bismaleimide resin. The biphenyl-based bismaleimide resins may include MIR-3000 (trade name; manufactured by Nippon Kayaku Co., Ltd.), MIR-5000 (trade name; manufactured by Nippon Kayaku Co., Ltd.), DI-0928 (trade name; manufactured by SHIFENG TECHNOLOGY CO., LTD.), DI-0929 (trade name; manufactured by Shifeng Technology Co., Ltd.) or other suitable maleimide resins.

In this embodiment, the bismaleimide resin preferably includes the bismaleimide-modified olefin-based resin and at least one of bismaleimide resin selected from the group consisting of the bismaleimide-modified polyphenylene ether resin and the bismaleimide-modified dicyclopentadiene-based resin. The bismaleimide resin more preferably includes the bismaleimide-modified olefin-based resin and the bismaleimide-modified polyphenylene ether resin, and may further include the bismaleimide-modified dicyclopentadiene-based resin. When the bismaleimide resin includes the bismaleimide-modified polyphenylene ether resin, the resin composition may have good peel resistance. When the bismaleimide resin includes the bismaleimide-modified dicyclopentadiene-based resin, the resin composition may have good heat resistance.

In this embodiment, a weight average molecular weight of the bismaleimide resin may be 500 g/mol to 5000 g/mol, preferably 600 g/mol to 4000 g/mol.

Based on a total usage amount of the resin composition being 100 parts by weight, a usage amount of the resin mixture (A) is 10 parts by weight to 30 parts by weight, preferably 16.5 parts by weight to 23.4 parts by weight.

### Liquid Rubber Resin (B)

The liquid rubber resin (B) is not particularly limited, and an appropriate liquid rubber resin may be selected according to needs. In this embodiment, the liquid rubber resin (B) may include LDM-02 (commercial product series; manufactured by Denka Company (Dainippon Ink & Chemicals, Inc.), LF-310T50 (trade name; manufactured by Nippon Steel Corporation), COD-103 (trade name; manufactured by Nippon Soda Co., Ltd.), a divinylbenzene-containing polymer (DVB resin series), a combination thereof or other suitable liquid rubber resins, preferably LDM-02 series.

Based on the total usage amount of the resin composition being 100 parts by weight, a usage amount of the liquid rubber resin (B) is 30 parts by weight to 50 parts by weight, preferably 35 parts by weight to 45 parts by weight.

### Inorganic Filler (C)

The inorganic filler (C) is not particularly limited, and an appropriate inorganic filler may be selected according to needs. For example, the inorganic filler (C) may be spherical. In this embodiment, the inorganic filler (C) may include silicon dioxide, preferably silicon dioxide with surface modification, and more preferably spherical silicon dioxide with surface modification. Specific examples of commercially available spherical silicon dioxide may include EQK0610-SMS (trade name; manufactured by Third Age Technology Co., Ltd.) or other suitable spherical silicon dioxides. A median particle size (particle size D50) of the inorganic filler (C) may be 0.3 microns to 3.0 microns, preferably 0.5 microns to 2 microns.

The inorganic filler (C) may include a surface-modified filler with acrylic or vinyl group, preferably a surface-modified silicon dioxide with acrylic or vinyl group. Compared with silicon dioxide without surface modification, surface-modified silicon dioxide with acrylic or vinyl group has better electrical properties, thereby enabling the resin composition to have good dielectric properties.

Based on the total usage amount of the resin composition being 100 parts by weight, a usage amount of the inorganic filler (C) is 25 parts by weight to 50 parts by weight, preferably 30 parts by weight to 40 parts by weight.

### Catalyst (D)

The catalyst (D) is not particularly limited, and an appropriate catalyst may be selected according to needs. For example, the catalyst (D) may include peroxide or other suitable catalysts. Specific examples of commercially available peroxides include Luperox F (trade name, which may be abbreviated as LuF; manufactured by ARKEMA company), DCP (trade name; manufactured by ARKEMA company), PercumylP (trade name; manufactured by Nippon Oil and Fats Co., Ltd.), Trigonox A-W70 (trade name; manufactured by AkzoNobel company), a combination thereof or other suitable peroxides.

Based on the total usage amount of the resin composition being 100 parts by weight, a usage amount of the catalyst (D) is 0.1 parts by weight to 2 parts by weight, preferably 0.5 parts by weight to 1 part by weight.

### Siloxane Coupling Agent (E)

The siloxane coupling agent (E) is not particularly limited, and an appropriate siloxane coupling agent may be selected according to needs. For example, the siloxane coupling agent (E) may include silane compounds having different functional groups. In this embodiment, the siloxane coupling agent (E) may include a vinyl silane compound, an acrylic silane, a combination thereof or other suitable siloxane coupling agents. Specific examples of commercially available siloxane coupling agents (E) include Z6030 (trade name; manufactured by Dow Corning Inc.), KBM503 (trade name; manufactured by Shin-Etsu Chemical Co., Ltd.) or other suitable siloxane coupling agents.

Based on the total usage amount of the resin composition being 100 parts by weight, a usage amount of the siloxane coupling agent (E) is 0.1 parts by weight to 5 parts by weight, preferably 0.2 parts by weight to 2 parts by weight. When the resin composition includes a siloxane coupling agent (E), the compatibility and cross-linking degree of the resin composition with glass fiber cloth and powder may be enhanced.

### <Preparation Method of Resin Composition>

The preparation method of the resin composition is not particularly limited. For example, each component of the resin composition are placed in a stirrer and stirred until they are uniformly mixed into a solution state, and a solvent may be added according to needs. After the blend is mixed uniformly, a liquid resin composition may be obtained.

The solvent may include toluene, xylene, acetone, 2-butanone, methyl isobutyl ketone (MIBK), cyclohexanone, dimethyl acetamide, a combination thereof or other suitable solvents. A usage amount of the solvent is not particularly limited, and an appropriate usage amount may be selected according to needs. In the liquid resin composition, a solid content may be 10% to 40%. In this embodiment, the solid content may be fixed at 35%. After this calculation, the usage amount of each component in the resin composition may be obtained.

It should be noted that the resin composition of the present invention may be processed into a resin coated copper substrate (RCC) according to actual design requirements. Since the resin composition of the present invention has good dielectric properties, peel resistance and heat resistance, the primer formed by the resin composition of the present invention may have good compatibility with prepreg and copper foil, such that the copper foil substrate (CCL) formed thereof also has low dielectric constant, low dissipation factor, high peel strength and good heat resistance, and thus has better reliability which may maintain the required electrical properties. In more detail, the dielectric constant of the resin coated copper substrate including the primer formed by the resin composition may be about 3.0 to 3.35, the dissipation factor thereof may be less than about 0.002, the peel strength between the copper foil and the prepreg may be greater than about 4 lb/in, and laminates with solder float values greater than 10 minutes were considered to be of known good quality. The dielectric constant of the pure primer formed by the resin composition may be about 2.71, the dissipation factor thereof may be about 0.00088.

Hereinafter, the present invention will be described in detail with reference to examples. The following examples are provided to describe the present invention, and the scope of the present invention includes the scope described in the following claims and their substitutions and modifications, and is not limited to the scope of the examples.

### SYNTHESIS EXAMPLE OF BISMALEIMIDE RESIN

### Synthesis Example 1: Bismaleimide-Modified Polyphenylene Ether Resin (PPE-BMI)

A small molecular weight polyphenylene ether resin material with a number average molecular weight (Mn) less than or equal to 12,000 or less than or equal to 10,000 (for example, Mn=500, 1400, 1600 or 1800) was dissolved in dimethylacetamide, and then potassium carbonate, tetrafluoronitrobenzene were added. The above reaction solution was heated to 140° C. and reacted for 8 hours, then cooled to room temperature, and then filtered to remove the solid. Methanol/water was used to precipitate the filtrate, and the precipitate is nitrated polyphenylene ether resin. Then, after the nitrated polyphenylene ether resin was dissolved in dimethylacetamide, it was hydrogenated at 90° C. for 8 hours to obtain aminated polyphenylene ether resin. Then, the aminated polyphenylene ether resin was placed in toluene, and maleic anhydride and p-toluenesulfonic acid were added thereto. It was heated to 120° C. and refluxed. After reacting for 8 hours, the bismaleimide-modified polyphenylene ether resin (PPE-BMI) was obtained.

### Synthesis Example 2: Bismaleimide-Modified Dicyclopentadiene-Based Resin (DCPD-BMI)

Dicyclopentadiene phenolic resin containing 1 mole of hydroxyl group (for example, weight average molecular weight of 1,300 (trade name ERM6140, manufactured by Songwon Industrial Co., Ltd.), weight average molecular weight of 1,100 (trade name ERM6115, manufactured by Songwon Industrial Co., Ltd.) or weight average molecular weight of 800 (trade name ERM6105, manufactured by Songwon Industrial Co., Ltd.)) and 1.25 moles of 4-halonitrobenzene (wherein the halogen may be fluorine, chlorine, bromine or iodine) were added to 6 moles of dimethylacetamide (DMAC) as the reaction solvent, and reacted at 120° C. for 300 minutes to perform the nitrification reaction. Next, hydrogen gas was introduced and the reaction was carried out at a temperature of 90° C. for 480 minutes to perform a hydrogenation reaction to form a modified dicyclopentadiene-type bisamine. Next, 3 moles of maleic anhydride and 9.7% by weight of toluenesulfonic acid were added, and reacted at 120° C. for 420 minutes to obtain a bismaleimide-modified dicyclopentadiene-based resin (DCPD-BMI), which has the structure represented by the Formula (2) above, and the average molecular weight may be 800 to 10000, preferably 1000 to 4000.

### EXAMPLES OF RESIN COMPOSITIONS

Examples 1 to 5 and Comparative Examples 1 to 4 of the resin composition are described below:

### Example 1 to Example 5 and Comparative Example 1 to Comparative Example 4

According to the contents of Table 1 and Table 2, the resin compositions of each experimental example were mixed using a mixed solvent of 50% toluene and 50% xylene to form a resin composition with a solid content of approximately 10 wt % to 40 wt %. The obtained resin composition was coated on the copper foil lamination surface for which the roughness Rz was less than 1 μm, the thickness was about 35 μm. After coating, the dry film was about 1 micron to 2 microns, which was then baked at 120° C. for 3 to 5 minutes to form a resin coated copper substrate. Two pieces of prepreg were stacked between two pieces of 35 μm-thick copper foil for which the roughness Rz was less than 1 μm, wherein a model of the prepreg is NPG188H (RC: 73%; 0.1 mm, manufactured by NAN YA PLASTICS CORPORATION), and then pressed using a hot press at a pressure of 25 kg/cm² and a temperature of 85° C., and maintained at a constant temperature for 20 minutes; then, after heating to 220° C. at a heating rate of 3° C./min, a constant temperature was maintained for 90 minutes. Next, the copper foil substrate was obtained after slowly cooling to 25° C. The obtained copper foil substrate was evaluated according to the following evaluation methods. The results are shown in Table 2.

TABLE 1

| | Symbol | Component/Compound |
|---|---|---|
| Resin | BMI-3000 | Trade name; manufactured by DMI. A weight |
| mixture | | average molecular weight is about 3000 g/mol. |
| (A) | PPE-BMI | Using the bismaleimide-modified |
| | | polyphenylene ether resin of Synthesis |
| | | Example 1. |
| | DCPD-BMI | Using the bismaleimide-modified |
| | | dicyclopentadiene-based resin of Synthesis |
| | | Example 2. |
| | MIR-3000 | Trade name; manufactured by Nippon Kayaku |
| | | Co., Ltd.. A weight average molecular weight |
| | | is about 776 g/mol. |
| Liquid | LDM-02 | Trade name; manufactured by Denka |
| rubber | | Company. |
| resin (B) | | |
| Inorganic | SiO₂ | Spherical silicon dioxide; trade name |
| filler (C) | | EQK0610-SMS, manufactured by Third Age |
| | | Technology Co., Ltd.. |
| Catalyst | Luperox F | Trade name; manufactured by ARKEMA |
| (D) | | company. |
| Siloxane | Z6030 | Trade name; manufactured by Dow Corning |
| coupling | | Inc.. |
| agent (E) | | |

TABLE 2

| Component | | Examples | | | | |
|---|---|---|---|---|---|---|
| (Unit: parts by weight) | | 1 | 2 | 3 | 4 | 5 |
| Resin mixture (A) | BMI-3000 | 3.0 | 8.4 | 13.0 | 12.9 | 8.5 |
| | PPE-BMI | 5.0 | 5.9 | 5.4 | 5.3 | 8 |
| | DCPD-BMI | 14.5 | 8.9 | 5.0 | — | — |
| | MIR-3000 | — | — | — | 0.7 | — |
| Liquid rubber resin (B) | LDM-02 | 35.7 | 35.4 | 39.1 | 44.4 | 42.3 |
| Inorganic filler (C) | SiO₂ | 40 | 39.6 | 35.9 | 35.6 | 40 |
| Catalyst (D) | Luperox F | 0.9 | 0.9 | 0.8 | 0.8 | 0.9 |
| Siloxane coupling | Z6030 | 0.9 | 0.9 | 0.8 | 0.3 | 0.3 |
| agent (E) | | | | | | |

| | | | | | | |
|---|---|---|---|---|---|---|
| Evaluation | Dielectric constant (Dk) | 3.34 | 3.29 | 3.31 | 3.31 | 3.33 |
| results | Dissipation factor (Df) | 0.00171 | 0.00172 | 0.00167 | 0.00158 | 0.00178 |
| | Peel strength (unit: lb/in) | 5.31 | 5.21 | 5.4 | 5.56 | 5.78 |
| | Heat resistance | OK | OK | OK | OK | OK |

| | |
|---|---|
| Component | Comparative Examples |

| | | | | |
|---|---|---|---|---|
| (Unit: parts by weight) | 1 | 2 | 3 | 4 |

| Resin mixture (A) | BMI-3000 | 18.3 | 11.5 | 23.6 | 57.5 |
|---|---|---|---|---|---|
| | PPE-BMI | — | — | — | — |
| | DCPD-BMI | 10.7 | — | — | — |
| | MIR-3000 | — | 17.7 | 6.0 | 11.3 |
| Liquid rubber resin (B) | LDM-02 | 30 | 29.3 | 29.7 | — |
| Inorganic filler (C) | SiO₂ | 40 | 40 | 39.5 | 30.9 |
| Catalyst (D) | Luperox F | 0.5 | 0.9 | 0.9 | 0.3 |
| Siloxane coupling | Z6030 | 0.5 | 0.6 | 0.3 | — |
| agent (E) | | | | | |

| | | | | | |
|---|---|---|---|---|---|
| Evaluation | Dielectric constant (Dk) | 3.3 | 3.3 | 3.31 | 3.25 |
| results | Dissipation factor (Df) | 0.0017 | 0.0017 | 0.0017 | 0.0018 |
| | Peel strength (unit: lb/in) | 3.8 | 3.22 | 3.75 | 3.3 |
| | Heat resistance | OK | NG | NG | NG |

### Evaluation Method

Dielectric constant (Dk): The evaluation was performed by using a dielectric analyzer (manufactured by Keysight Technologies) to test the dielectric constant at a frequency of 10G Hz. When the dielectric constant is smaller, it shows that the resin composition has good dielectric properties.

Dissipation factor (Df): The evaluation was performed by using a dielectric analyzer (manufactured by Keysight Technologies) to test the dissipation factor at a frequency of 10G Hz. When the dissipation factor is smaller, it shows that the resin composition has good dielectric properties.

Peel strength: The evaluation was performed according to the IPC-TM-650-2.4.8 test method to test the peel strength of the metal substrate. A tensile testing machine was used to test the peel strength between the copper foil and the circuit carrier substrate. When the peel strength is larger, it shows that the resin composition has good ability to resist peeling off from the circuit carrier substrate, that is, it has good peel resistance.

Heat resistance: The copper foil substrate sample (i.e. laminates) was placed in an oven at 288° C. to induce blistering, and the time to blister was measured from the initial time to the appearance of the first blister. If the laminates with solder float values is greater than 10 minutes, it is considered to be of known good quality (abbrev. “OK”), and if the laminates with solder float values less than 10 minutes, it is considered to be of known NG quality (abbrev. “NG”).

### Evaluation Results

It may be seen from Table 2 that when the resin composition includes a resin mixture (A), a liquid rubber resin (B), an inorganic filler (C), a catalyst (D) and a siloxane coupling agent (E), and the resin mixture (A) includes a bismaleimide resin (Examples 1 to 5), the resin composition has good dielectric properties, peel resistance and heat resistance at the same time.

In addition, compared with the resin composition (Comparative Examples 1 to 4) in which the usage amount of the resin mixture (A) is not in the range of 10 parts by weight to 30 parts by weight based on the total usage amount of the resin composition being 100 parts by weight, the resin compositions (Examples 1 to 5) in which the usage amount of the resin mixture (A) is within the above range have greater peel strength, that is, better peel resistance.

In addition, compared with the resin composition (Comparative Examples 1 to 4) in which the bismaleimide resin does not include the bismaleimide-modified polyphenylene ether resin (PPE-BMI), the resin composition (Examples 1 to 5) in which the bismaleimide resin includes the bismaleimide-modified polyphenylene ether resin have greater peel strength, that is, better peel resistance.

In addition, compared with the resin composition (Comparative Examples 2 to 4) in which the bismaleimide resin does not include the bismaleimide-modified polyphenylene ether resin (PPE-BMI) and the bismaleimide-modified dicyclopentadiene-based resin (DCPD-BMI), the resin composition (Examples 1 to 3) in which the bismaleimide resin includes the bismaleimide-modified polyphenylene ether resin and the bismaleimide-modified dicyclopentadiene-based resin have greater peel strength and good heat resistance, that is, better peel resistance and heat resistance.

In summary, the resin composition of the present invention includes a resin mixture (A), a liquid rubber resin (B), an inorganic filler (C), a catalyst (D) and a siloxane coupling agent (E), and the resin mixture (A) includes a bismaleimide resin, so it has good dielectric properties, peel resistance and heat resistance. Therefore, the resin composition has good applicability.

Although the present invention has been disclosed above through embodiments, they are not intended to limit the present invention. Anyone with ordinary knowledge in the relevant technical field may make some changes and modifications without departing from the spirit and scope of the present invention. Therefore, the protection scope of the present invention shall be determined by the appended patent application scope.

What is claimed is:

1. A resin composition comprising:
a resin mixture (A) comprising a bismaleimide resin;
a liquid rubber resin (B);
an inorganic filler (C);
a catalyst (D); and
a siloxane coupling agent (E).

2. The resin composition according to claim 1, wherein the bismaleimide resin comprises a bismaleimide-modified olefin-based resin, a bismaleimide-modified polyphenylene ether resin, a bismaleimide-modified dicyclopentadiene-based resin or a combination thereof.

3. The resin composition according to claim 2, wherein the bismaleimide resin further comprises a biphenyl-based bismaleimide resin.

4. The resin composition according to claim 1, wherein a weight average molecular weight of the bismaleimide resin is 500 g/mol to 5000 g/mol.

5. The resin composition according to claim 1, wherein based on a total usage amount of the resin composition being 100 parts by weight, a usage amount of the resin mixture (A) is 10 parts by weight to 30 parts by weight.

6. The resin composition according to claim 1, wherein the liquid rubber resin (B) comprises LDM-02, LF-310T50, COD-103, a divinylbenzene-containing polymer or a combination thereof.

7. The resin composition according to claim 1, wherein the inorganic filler (C) comprises silicon dioxide.

8. The resin composition according to claim 1, wherein the inorganic filler (C) comprises a surface-modified silicon dioxide with acrylic or vinyl group.

9. The resin composition according to claim 1, wherein the inorganic filler (C) has a median particle size of 0.3 microns to 3.0 microns.

10. The resin composition according to claim 1, wherein the siloxane coupling agent (E) comprises vinyl silane compound, an acrylic silane or a combination thereof.

11. The resin composition according to claim 1, based on a total usage amount of the resin composition being 100 parts by weight, a usage amount of the liquid rubber resin (B) is 30 parts by weight to 50 parts by weight, a usage amount of the inorganic filler (C) is 25 parts by weight to 50 parts by weight, a usage amount of the catalyst (D) is 0.1 parts by weight to 2 parts by weight, a usage amount of the siloxane coupling agent (E) is 0.1 parts by weight to 5 parts by weight.
